(19) United States
(12) Patent Application Publication
(10) Pub. No.: US 2023/0162134 A1
(43) Pub. Date: May 25, 2023

(54) METHOD AND SYSTEM FOR GENERATING ACCURATE SHIPPING COSTS ACROSS CARRIERS

(71) Applicant: Target Brands, Inc., Minneapolis, MN (US)

(72) Inventors: ADAM HOLLENBECK, Minneapolis, MN (US); NATHANIEL CROWE, Minneapolis, MN (US); RAJESH GOGINENI, Minneapolis, MN (US); DILIP SUNDARRAJ, Minneapolis, MN (US); NIRANJAN KURRA, Minneapolis, MN (US); SEAN BEINS, Minneapolis, MN (US); ALYSON IRIZARRY, Charlottesville, VA (US); JUNE ANDREW RABIN, Minneapolis, MN (US)

(21) Appl. No.: 17/531,088

(22) Filed: Nov. 19, 2021

(51) Int. Cl. G06Q 10/08; G06Q 30/02

(52) U.S. Cl. CPC G06Q 10/08345; G06Q 30/0206

(57) ABSTRACT

Methods and systems for estimating shipping costs with at least one vendor are provided, including methods and systems for determining shipping rates with high accuracy and scalability, for any shipment of certain characteristics and service levels. Methods and systems include a database containing information on contracted shipping rates, zone mappings, and accessorial charges with at least one vendor. When this information used in conjunction with information about a package's shipping origin, shipping destination, dimensions, weight, and eligible service levels to estimate the shipping cost of a package for at least one vendor.

### TECHNICAL FIELD

The present application relates generally to package shipping services, and in particular to methods and systems for determining shipping rates.

### BACKGROUND

With the growth of online shopping, individuals and businesses have depended on large carriers to ship packages across the country, often paying a significant amount. To reduce these shipping costs, individuals and business will estimate the cost of using each carrier and choose the carrier that they believe will be the cheapest.

A conventional method to estimate shipping rate is based on a flat average rate from a particular origin location to a particular end location. However, historical data-based decision-making results in inefficient carrier selection, since often the selected carrier will be the one having a flat average rate that is below the actual rate. Accordingly, an individual or business may select a carrier based on an expected rate (i.e., the flat average rate) but may be charged a higher rate when the carrier is actually selected, for example due to variability between the actual rate for a package having nonstandard dimensions or weight and the flat average rate.

Alternatively, large carriers offer APIs from which individuals and businesses can receive shipping cost information. Although this provides accurate shipping cost information, these APIs are not fast enough to handle the volume necessary to be used at scale, particularly for a large retail enterprise. It is particularly inefficient and impractical for an enterprise to request a rate calculation from every carrier for every package prior to selection of a carrier. This is particularly the case because, at times, a carrier selection may change between a time at which an order is originally processed and a time the order is shipped.

In view of the above and other disadvantages of existing systems, improvements are desirable.

### SUMMARY

In general, this patent document relates to a decision system useable by a large retail enterprise to improve carrier selections in package shipping services. More specifically, this document relates to methods and systems for determining shipping rates, with high accuracy and scalability, for any shipment of certain characteristics and service levels across a plurality of third party carriers.

In one aspect, a method of estimating shipping rates using a data processing device in communication with a database, an input device, and an output device. The method includes retrieving information on contracted shipping rates, zone mappings, and accessorial charges from a database maintained by a retail organization, the database storing contracted shipping rates, zone mappings, and accessorial charges of a plurality of different carriers and specific to the retail organization. The method also includes receiving a rate calculation request from a user, the rate calculation request including a shipping origin, a shipping destination, dimensions, weight, and eligible service levels for a package, and using the information retrieved from the database and the input from the user to generate a calculated shipping cost for the package associated with at least one carrier from among the plurality of different carriers.

In a further aspect, a system for estimating shipping costs is provided. The system includes a database containing information on contracted shipping rates, zone mappings, and accessorial charges associated with each of a plurality of carriers and a retail organization, an input device, a display device, and a data processing device in communication with the database, the input device, and the display device. The data processing device is configured to receive a rate calculation request from a user, the rate calculation request including a shipping origin, a shipping destination, dimensions, weight, and eligible service levels for a package, and use the information retrieved from the database and the input from the user to generate a calculated shipping cost for the package associated with at least one carrier from among the plurality of different carriers.

In a further aspect, a non-transitory computer-readable storage medium comprising computer-executable instructions is disclosed. The instructions, when executed by a processing device of a computing system, cause the computing system to: retrieve information on contracted shipping rates, zone mappings, and accessorial charges from a database maintained by a retail organization, the database storing contracted shipping rates, zone mappings, and accessorial charges of a plurality of different carriers and specific to the retail organization; receive a rate calculation request from a user interface, the rate calculation request including a shipping origin, a shipping destination, dimensions, weight, and eligible service levels for a package; use the information retrieved from the database and the input from the user to generate a plurality of calculated shipping costs for the package from a plurality of different carriers without requiring submission of rate requests to any of a plurality of carriers associated with the plurality of calculated shipping costs; and display, in the user interface, at least one of the plurality of calculated shipping costs.

Other objects and advantages of the invention will be apparent to one of ordinary skill in the art upon reviewing the detailed description of the invention.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic diagram illustrating an example multi-carrier environment implemented by a retail enterprise in which aspects of the present disclosure may be implemented.

FIG. 2 is a flow diagram showing an embodiment of the process steps to estimate shipping costs.

FIG. 3 is a flow diagram showing an embodiment of the process steps to estimate shipping costs.

FIG. 4 is a message flow diagram illustrating process flow of a parcel quote service for multiple carriers across a retail organization.

FIG. 5 is a block diagram of an architecture of a carrier rate calculation system, according to an example embodiment.

FIGS. 6A-6C illustrate example tables showing carrier rate information across a plurality of carriers defined by contracts with a retail enterprise.

FIG. 7 illustrates an example computing system on which aspects of the present disclosure may be implemented.

FIG. 8 is an example carrier rate report generated by the carrier rate calculation system of the present disclosure.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “having,” and “has” are interchangeable and not intended to be limiting. The term “such as” also is not intended to be limiting. For example, the term “including” shall mean “including, but not limited to.”

All ranges provided herein include the upper and lower values of the range unless explicitly noted. Although values are disclosed herein when disclosing certain exemplary embodiments, other embodiments within the scope of the pending claims can have values other than the specific values disclosed herein or values that are outside the ranges disclosed herein.

Terms such as “substantially” or “about” when used with values or structural elements provide a tolerance that is ordinarily found during testing and production due to variations and inexact tolerances in factor such as material and equipment.

Generally speaking, the present disclosure relates to systems and methods for generating, at scale, accurate rate estimates usable by an enterprise for carrier selection. In particular, the present disclosure relates to creation and utilization of internal models at a retail enterprise which may be based on contracted rates with a variety of carriers, and which may be used to generate specific rates for particularized packages or shipments having unique characteristics. Because the systems and methods described herein allow a package to be rated specifically against not only a base rate (e.g., a contracted rate with a carrier) but also any volume discounts that may be applied, accessorial charges, variance due to dimensions or weight, surcharges due to delivery area, peak season events, or fuel, the overall system described herein generates an accurate estimate of a carrier charge for a particularized package, for a particular retail enterprise, without requiring a retail enterprise to separately obtain a specific quote from each carrier for each package. In some instances, a retail enterprise may generate detailed, accurate estimates of cost across a variety of carriers for a single package concurrently, thereby allowing the enterprise to select an optimal carrier without requiring the enterprise to make often inaccurate assumptions regarding rates that would be charged.

In example implementations, the carrier rate calculation systems described herein can, because they are implemented within a particular organization such as a retail organization, satisfy a high volume of rate calculation requests. In particularly large retail organizations, carrier decisions are made at scale. For example, tens of thousands of shipments per hour may be made by a given retailer. Because carrier rate calculations may be performed for a large number of carriers per shipment, and still further may require multiple iterations of rate calculations per shipment, a very high volume of rate calculation requests are required to be processed.

Still further, it can be non-advantageous to submit all such rate calculation requests to carriers directly, because such requests may provide internal information of the retailer regarding volumes of shipments handled, particular origins and destinations of shipment, as well as shipping profiles. Such information is largely viewed as proprietary to the retail organization, since only a portion of that information would otherwise be made available to any given carrier (e.g. limited by the extent to which carrier is ultimately selected for a given shipment). Use of an internal tool to generate rate calculations avoids requiring submission of such rate calculations to third parties.

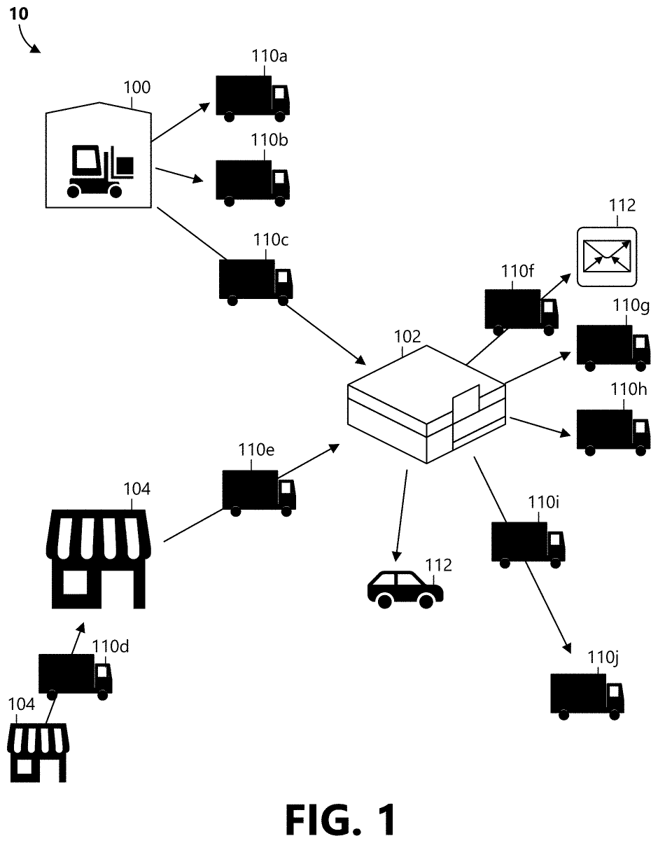

Referring first to FIG. 1, an example supply chain network 10 in which aspects of the present disclosure may be implemented is shown. In the example supply chain network 10, a plurality of locations are served by a plurality of different carriers to move items from location to location. For example, the supply chain network 10 may include a warehouse 100, one or more intermediate distribution centers 102, and a plurality of retail locations 104. The warehouse 100 may be, for example, a location at which goods are received from vendors, and from which goods are distributed to the intermediate distribution centers 102 and/or retail locations 104. The intermediate distribution centers 100 to may be locations that receive items from the warehouse 100 for distribution to retail locations 104, or may be smaller re-distribution centers that receive goods from both warehouses 100 and retail locations 104, and which provide last mile delivery services to customers.

In the example shown, each of the warehouse 100, intermediate distribution center 102 and retail locations 104 may be serviced by one or a plurality of carriers. In the example shown, the warehouse 100 is serviced by a plurality of different line haul carriers 110a-c, and the retail locations are also serviced by line haul carriers 110d-e, respectively. The intermediate distribution center 102 may be serviced by linehaul carriers 110f-j as well, but may include a combination of such carriers in which multiple line haul carriers are involved in a shipment to a retail customer, or a linehaul carrier may be used in combination with other transportation modes (e.g., Postal Service 111) for delivery of items to a retail customer. Still further, as shown in intermediate distribution center 102 may be serviced by third-party contract delivery services such as crowd sourced delivery services 112. It is noted that the retail locations 104 may also be serviced by, for example, any of the carriers servicing the intermediate distribution center 102.

Generally speaking, in a supply chain arrangement such as is seen in FIG. 1, due to the high volume of goods flowing through such a supply chain 10, a retail enterprise will have particular, contracted rates with the various carriers based on intended volume and routes serviced by the particular carrier. Individual carriers may have contracts for routes between some or all of the retail locations 104, intermediate distribution centers 102, and warehouse 100.

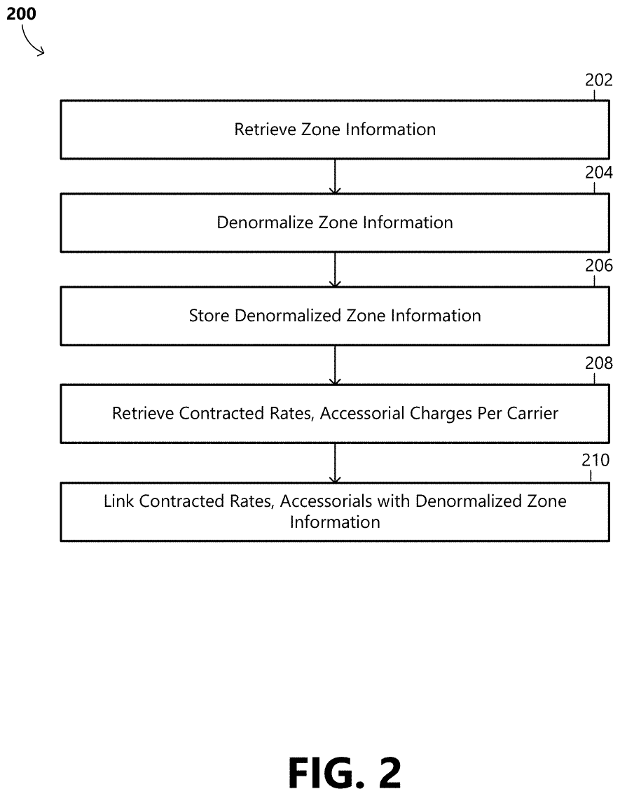

Referring to FIG. 2, a flow diagram 200 is provided depicting process steps to estimate shipping costs for particular carriers. First, at step 202, zone information is pulled. Zone information may correspond to, for example, a region in which an intended delivery resides (e.g. a customer delivery location or a location at which a store or intermediate distribution center resides). The zone information can, in some embodiments, relate to or refer to a ZIP Code (e.g., either a 3-digit or 5-digit zip code). Zone information may be used, for example, by some contracted carriers to define general distances from origins to destinations, and therefore may set a flat base rate for shipping to a particular zone. After this information is pulled, it is denormalized in step 204. The normalization may include obtaining and localizing particular rate information for a specific origin and his own destination. Denormalized zone information is then stored in a database 124, at step 206.

After the denormalized zone information is stored in the database 124, information on contracted rates and accessorial charges is retrieved in step 208. Contracted rates may include a base rate for delivery from a particular origin to a zone. Examples of accessorial charges include surcharges for delivery to particular residential or commercial addresses, delivery of package dimensions or weights, delivery area surcharges, and carrier peak season. Additionally, accessorial charges may include tolls or other types of surcharges. In some further embodiments, the information retrieved at step 208 further includes fuel surcharge information. In step 210, this information is linked with the denormalized zone information and stored in the database 124. At this stage, delivery information for a particular package between an origin and his own destination point, including base rates and any accessorials or surcharges, is stored for a particular carrier.

It is noted that, referring to FIG. 2 generally, this process may be repeated for each of a plurality of carriers, each of which has a different base rate, zone definition, set of accessorial charges and/or charge rates, or surcharges that may be associated with different shipments or shipment classes at different times. As such, in example embodiments, the above process may be performed for all zones and all potential package sizes supported by a given carrier, assuming then-current accessorial charges and other surcharges that may be in place. In further embodiments, the above process may be performed for all carriers at a particular location, or for all carton sizes and delivery methods of a given carrier (e.g., the various service levels or delivery speeds from the carrier).

In some examples, the above process may be performed for all carriers from a particular location given a particular carton size that would be appropriate to be used for the specific carrier. It is noted that in such an example application, such that a volume or dimension of one or more items may be used to select eligible cartons from a variety of carriers, and rates for each of a plurality of carriers may be calculated for those appropriate carton sizes. In such an example, this may be performed at a time of carrier, or carton, selection, with rates being used to assist in the carrier selection process.

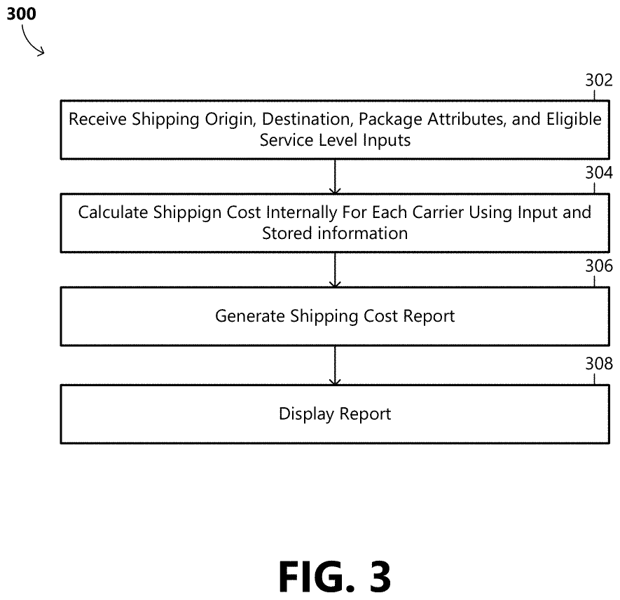

Referring now to FIG. 3, a further example method 300 is shown, implementing further aspects of the carrier rate calculations described herein. In examples, the method 300 may be performed after the calculations described above in conjunction with FIG. 2 are executed.

In the example shown, with all of the denormalized zone information, contracted rates, and accessorial charges, stored in the database 124, the shipping origin, shipping destination, package dimensions, package weight, and eligible service levels may be received from a user at step 302. That is, the shipping origin, shipping destination, package dimensions, package weight, and service levels may be received in a user interface, for example input by the user. In an embodiment, the eligible service levels for a package are the delivery options for each carrier with which the package could be delivered by a deadline date.

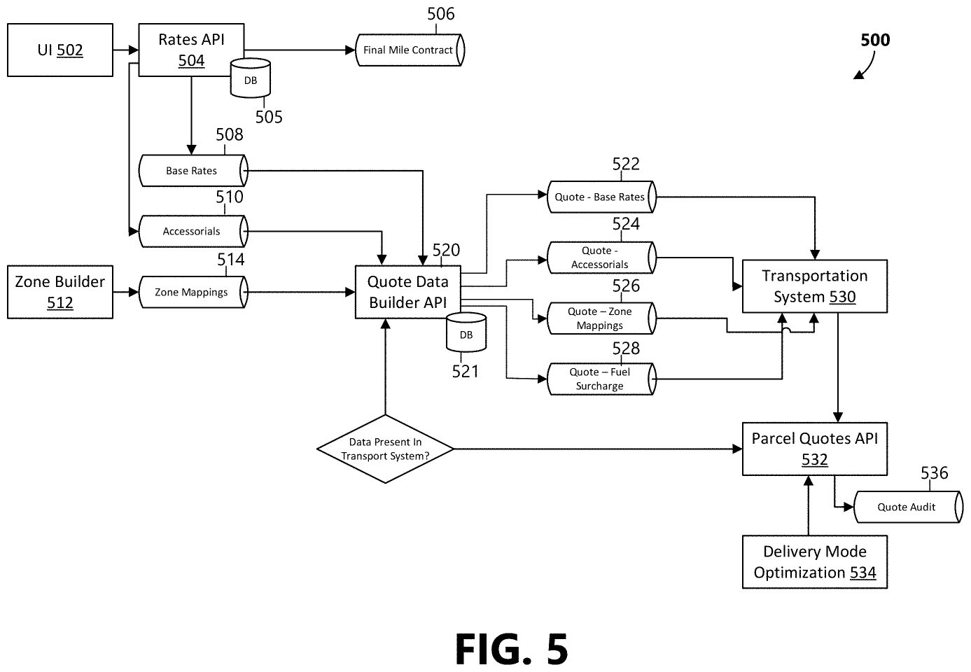

At step 304, the information input by the user in step 302 is used with the data stored in the database 124 to calculate a shipping cost for each carrier having a valid shipping option. A report on the shipping costs is generated in step 306, and displayed in step 308. The display of such shipping costs may be provided, for example, in a user interface such as the one seen in FIG. 9, below. Other example user interfaces, or data outputs, are possible as well. For example, in some examples, an API may be exposed that provides such data, as described in conjunction with FIG. 5.

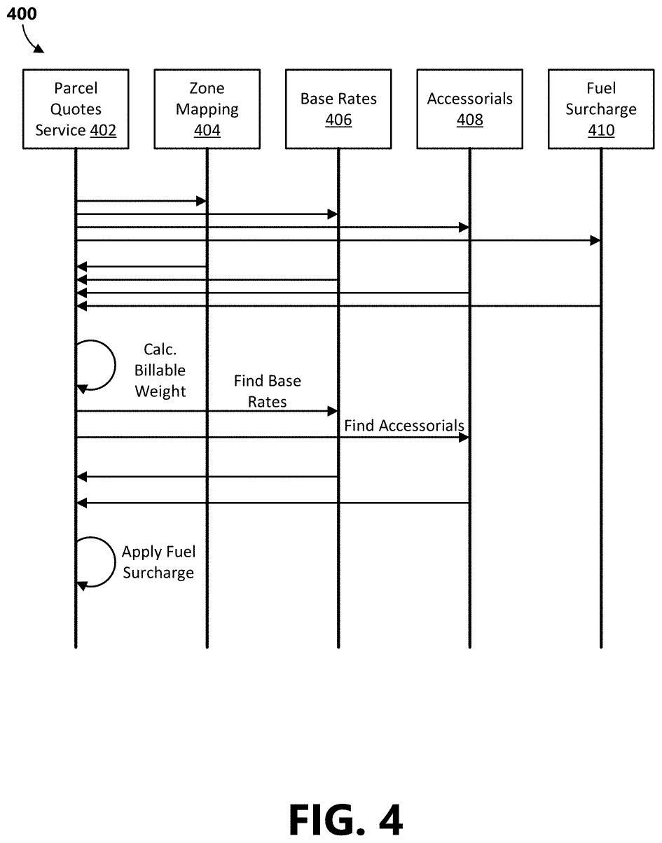

FIG. 4 illustrates an example process flow 400 by which individual parcel quotes may be generated. In the example shown, upon receiving a parcel quote request, e.g., at a parcel quote service 402 provided by a rates API as described below, separate requests may be issued to a zone mapping service 404, a base rate service 406, and accessorial service 408, and a fuel surcharge surface 410. Each of those services may then return responses, for example including components of a partial quote given the parameters provided by the parcel quote request. In examples, the parcel quote requests will include those items noted above, namely the shipping origin, shipping destination, package dimensions, package weight, and service levels.

The zone mapping service 404 will determine an appropriate zone given the parcel destination and parcel origin, as well as a particular carrier for which the request is submitted. For example, different carriers may define different zones, and as such the zone will be specific to the carrier, origin, and destination.

The base rate service 406 will generate a base rate that is associated with the particular carrier, given the zone identified by the zone mapping service 404. The base rate may be a rate that is defined by a contract, as well as any bulk discounts that may be in place at the time the rate is requested. Additionally, the accessorial service 408 will generate a set of access Orioles given the carrier, the base rate, and any anticipated adjustments from the base rate is that may occur given the time of year, volume, or other variabilities.

The fuel surcharge service 410 will generate a fuel surcharge if such a surcharge is likely to be charged by a carrier. Such a fuel surcharge may be predicted based on past carrier behavior, for example based on a time of year, or based on recent charges from that carrier, or external factors such as market conditions.

Upon receipt of the relevant zones, base rates, accessorials, and fuel surcharges for each of a plurality of carriers, the parcel quote service 402 may calculate a billable weight for a given package, and issue revised requests to determine base rates and accessorials for the package having a particular weight. The parcel quote service 402 may then apply a fuel surcharge based on the retrieved expected fuel surcharges for a selected carrier, to generate an example one or more rates for the carriers that are selected.

Referring now to FIG. 5, an example architecture diagram of a carrier rate system 500 is shown. The carrier rate system 500 may include each of the services described above in conjunction with FIG. 4 to perform the methods of FIGS. 2-3, within an enterprise supply chain 10.

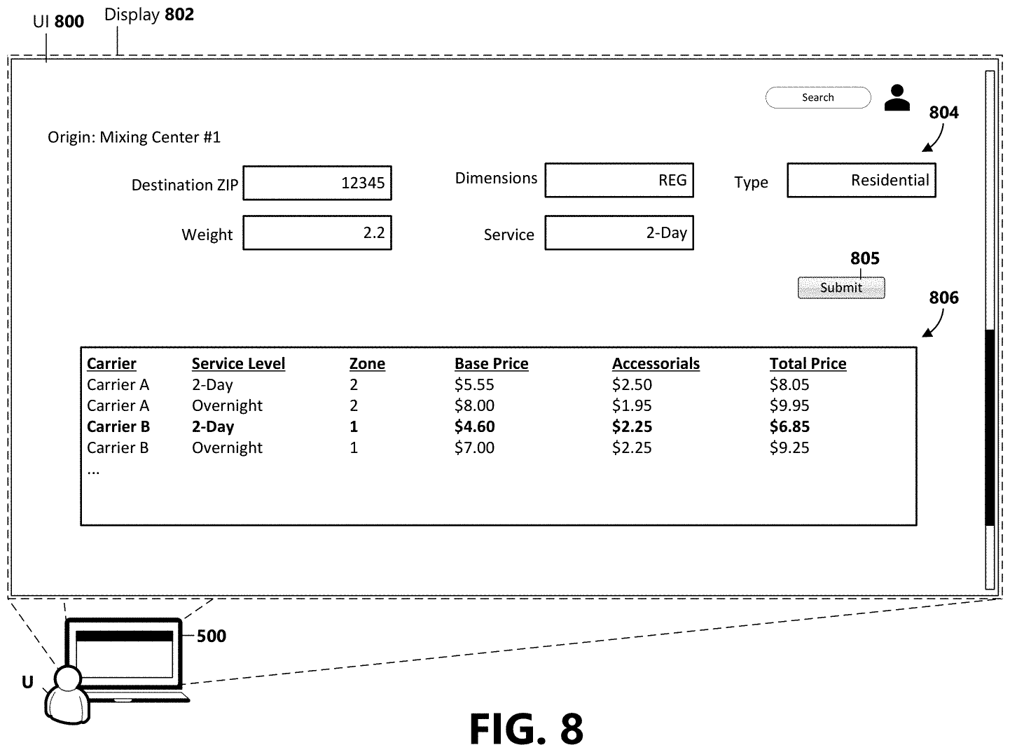

In the example shown a user interface 502, for example as described below in conjunction with FIG. 8, may be used to submit carrier rate calculation requests and view carrier rate calculations provided by a rates API 504. The rates API 504 accesses carrier contract data 506 which defines, at least in part, and charges for particular carriers between origins and destinations, such as customer locations. The carrier contract data 506 is derived from agreements between a retail enterprise and a plurality of different carriers, and defines rates that will be charged to the particular retail enterprise by each of the carriers and according to the terms used. Accordingly, in some examples the carrier contract data 506 may be referred to as a “last mile contract” because it defines rates charged by a carrier for delivery to customers on behalf of the retail enterprise. Notably, the carrier contract data 506 is determined at the time of agreement with each carrier, and therefore no further access of carrier information is required at the time a delivery cost calculation is performed by the retail enterprise. The rates API 504 may have an associated data store 505 which aggregates rate components for delivery via the user interface 502.

In the example shown, the rates API 504 submits requests to a base rates service 508, as well as an accessorials service 510. The base rates service 508 and accessorial service 510 provide base rates and accessorials for identified carriers to a quote data builder API 520, which maintains such rates in a data storage 521. Additionally, a zone builder tool 512 provides zone mappings 514 for each of a plurality of carriers to the quote data builder API 520. As noted above, each carrier may define its own zones around or in proximity to individual or in locations, such as warehouses or stores for a retail enterprise.

In the example shown, the quote data builder API 520 generates quote components, such as a base rate quote 522, and accessorials quote 524 a zone mapping 526 for the quote, and a fuel surcharge 528 for the quote. Such a quote components are provided to a transportation system 530, in the example shown. Additionally, the transportation system 530 may expose the quote to a parcel quotes API 532. The parcel quotes API 532 may provide the partial quotes back to a user interface, such as user interface 502. Additionally, the parcel quotes API 532 may make such partial quotes available to a delivery mode optimization tool 534 in examples, the delivery mode optimization tool will, based on a promised delivery date, delivery options available at a particular origin, and the exposed parcel quotes, select a particular delivery mode (e.g. a specific carrier) that most efficiently will deliver a particular parcel on behalf of the retail enterprise. In some examples, an audit data stream 536 of parcel quotes may ne provided from the parcel quotes API 532 as well, for storage and analysis by external tools managed by the enterprise.

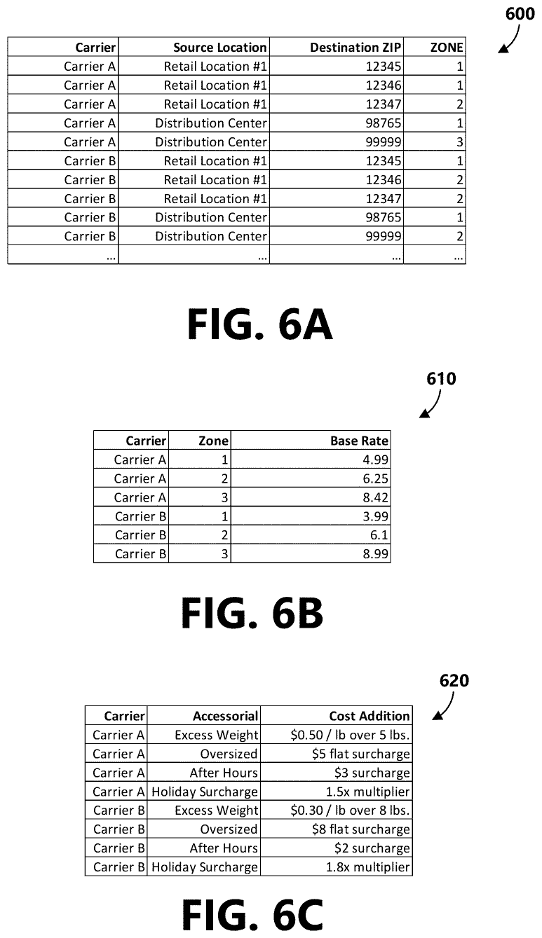

Referring now to FIGS. 6A-6C, example data storage for zones, base rates, and accessorials are shown for each of a plurality of carriers. As illustrated in FIG. 6A, a table 600 illustrates data highlighting that particular zone may be defined as including one or more ZIP Codes as associated with an origin. Accordingly, an origin destination pair may be included within a particular zone, which defines an area of service having a constant base rate for that carrier.

As illustrated in FIG. 6B, a table 610 may maintain a set of base rates are defined for a particular carrier and zone. The base rates may be defined, for example, based on a contract with the carrier. As seen in table 610, various rates may be set for different zones, with each zone being defined by a set of zip codes that are a general predetermined or average distance from an origin of a shipment. Additionally, as seen in FIG. 6C, a table 620 storing accessorials for each of a plurality of carriers are shown. Accessorials may include, for example, types of events that may indicate a surcharge (e.g., weight, time of day, dimensions (oversize), or various other surcharge types).

It is noted that, as seen in FIG. 6A, different carriers may define different zones using different collections of ZIP Codes associated with a particular origin. In the example table 600, carriers A and B are defined as using different zones (Zone 1 and Zone 2) for delivery from the same origin (“Retail Location #1”) to the same destination ZIP code. Additionally, each carrier may have a different base rate or accessorial rates or calculation bases for such accessorials for a given base rate or destination. Various types of surcharges may be maintained as well, for example consistently charged surcharges that are contracted.

It is noted that the tables 600, 610, 620 may be maintained by the various services described above for generation of quotes for particular deliveries, and may be maintained in a common database or distributed across a computing platform having a plurality of accessible data sources. Additionally, other data may be stored, such as expected fuel surcharges based on historical deliveries within the same zone, or recent deliveries by the same carrier. Such fuel surcharge data may be aggregated periodically from actual carrier charges that are incurred.

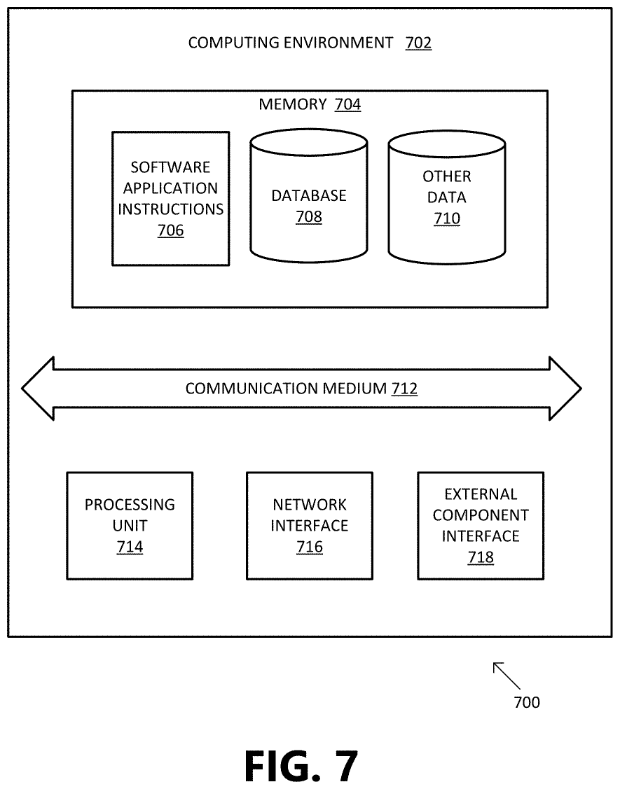

FIG. 7 illustrates an example system 700 with which disclosed systems and methods can be used. In an example, one or more such systems 700 may be used to implement the carrier rates system described above in conjunction with FIG. 5, within a retail enterprise having a supply chain such as is seen in FIG. 1.

In an example, the system 700 can include a computing environment 702. The computing environment 702 can be a physical computing environment, a virtualized computing environment, or a combination thereof. The computing environment 702 can include memory 704, a communication medium 712, one or more processing units 714, a network interface 716, and an external component interface 718.

The memory 704 can include a computer readable storage medium. The computer storage medium can be a device or article of manufacture that stores data and/or computer-executable instructions. The memory 704 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 704 can store various types of data and software. For example, as illustrated, the memory 704 includes software application instructions 706, one or more databases 708, as well as other data 710.

The communication medium 712 can facilitate communication among the components of the computing environment 702. In an example, the communication medium 712 can facilitate communication among the memory 704, the one or more processing units 714, the network interface 716, and the external component interface 718. The communications medium 712 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 714 can include physical or virtual units that selectively execute software instructions, such as the software application instructions 706. In an example, the one or more processing units 714 can be physical products comprising one or more integrated circuits. The one or more processing units 714 can be implemented as one or more processing cores. In another example, one or more processing units 714 are implemented as one or more separate microprocessors. In yet another example embodiment, the one or more processing units 714 can include an application-specific integrated circuit (ASIC) that provides specific functionality. In yet another example, the one or more processing units 714 provide specific functionality by using an ASIC and by executing computer-executable instructions.

The network interface 716 enables the computing environment 702 to send and receive data from a communication network. The network interface 716 can be implemented as an Ethernet interface, a token-ring network interface, a fiber optic network interface, a wireless network interface (e.g., Wi-Fi), or another type of network interface.

The external component interface 718 enables the computing environment 702 to communicate with external devices. For example, the external component interface 718 can be a USB interface, Thunderbolt interface, a Lightning interface, a serial port interface, a parallel port interface, a PS/2 interface, or another type of interface that enables the computing environment 702 to communicate with external devices. In various embodiments, the external component interface 718 enables the computing environment 702 to communicate with various external components, such as external storage devices, input devices, speakers, modems, media player docks, other computing devices, scanners, digital cameras, and fingerprint readers.

Although illustrated as being components of a single computing environment 702, the components of the computing environment 702 can be spread across multiple computing environments 702. For example, one or more of instructions or data stored on the memory 704 may be stored partially or entirely in a separate computing environment 700 that is accessed over a network.

Depending on the size and scale of the computing environment 702, it may be advantageous to include one or more load balancers to balance traffic across multiple physical or virtual machine nodes. In an example, the node balancer may be a node balancer product provided by F5 NETWORKS, INC. of Seattle, Wash.

Aspects of the platform 700 and the computing environment 702 can be protected using a robust security model. In an example, users may be made to sign into the system using a directory service, such as ACTIVE DIRECTORY by MICROSOFT CORPORATION of Redmond, Wash. Connection and credential information can be externalized from jobs using an application programming interface. Credentials can be stored in an encrypted repository in a secured operational data store database space. Privileges can be assigned based on a collaboration team and mapped to a Lightweight Directory Access Protocol (LDAP) Group membership. A self-service security model can be used to allow owners to assign others permissions on their objects (e.g., actions).

Each node may be configured to be capable of running the full platform 700, such that portal can run and schedule jobs and serve the portal user interface as long as a single node remains functional. The environment 702 may include monitoring technology to determine when a node is not functioning so an appropriate action can be taken.

Referring to FIG. 8, an example user interface 800 displaying carrier rate calculations generated by a carrier rate system as described herein is shown. The user interface 800 may be implemented, for example, using the architecture as described in conjunction with FIG. 5, with the user interface 800 corresponding to user interface 502 described above. The user interface may present the user interface 800 on a display 802 associated with a particular computing device 500.

In the example shown, the user interface 800 includes a rate request submission form 804, as well as a rate display region 806. The rate request submission form 804 includes user input regions configured to receive a definition of a rate requests, for example an origin, a destination, package dimensions, package weight, and a promise delivery timeframe. A submission option 805 may be selected by a user U to submit a rate calculation request. In response to selection of the submission option 805, the rate display region 806 may be populated with one or more rate options that are calculated, optionally in accordance with any constraints identified in the rate request. As illustrated in the user interface 800, rates that satisfy the promise delivery timeframe for the particular origin and destination are provided, with the origin destination pair representing different zones for different carriers, each having individualized base rates, accessorials, and surcharges.

In some example embodiments, the user interface 800 allows a user U to select a particular one of the displayed rates. In other embodiments, the user interface 800 merely displays those rates, with the particular rate selected being identified by a delivery mode optimization system as described above. In still further embodiments, the user interface 800 will only display a recommended rate as determined from a delivery mode optimization decision made by In some further examples, such as the one shown, the user interface will display a listing of feasible rate and service levels from one or more carriers, and may highlight a lowest-cost option that meets ad particular desired shipping window, or otherwise may elect a carrier and service level that corresponds to a delivery mode selected via a delivery mode optimization service.

Referring to FIGS. 1-8 generally, it is noted that the carrier rate system described herein has a number of advantages relative to existing approaches. In particular, because the carrier rate calculations generated by such a system are significantly more accurate than the estimates previously relied upon by large retail enterprises, they may be more reliably used to accurately select an appropriate, most efficient carrier for a particular package. Still further, the carrier rate system described herein is able to rapidly generate a large number of rate calculations for different carriers concurrently, rather than requiring an enterprise to submit rate requests to each carrier to obtain quotes, especially when a package size or service level may change between a time of initial assessment and when a carrier and package determination is ultimately made. This allows retail enterprises to consistently assess carrier rates at multiple times during a packaging and shipping process without requiring submission of rate requests to many carriers repeatedly who ultimately will not be the carrier selected. Accordingly, accuracy may be maintained by the retail enterprise, without requiring that retail enterprise to divulge to carriers volumes of packages shipped by the retail enterprise or rely upon those carriers to independently generate cost assessments. Additional advantages are provided as well, and are reflected in the features of the present disclosure described herein.

The above specification, examples and data provide a complete description of the manufacture and use of the composition of the invention. Since many embodiments of the invention can be made without departing from the spirit and scope of the invention, the invention resides in the claims hereinafter appended.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of estimating shipping rates using a data processing device in communication with a database, an input device, and an output device, the method comprising:
retrieving information on contracted shipping rates, zone mappings, and accessorial charges from a database maintained by a retail organization, the database storing contracted shipping rates, zone mappings, and accessorial charges of a plurality of different carriers and specific to the retail organization;
receiving a rate calculation request from a user, the rate calculation request including a shipping origin, a shipping destination, dimensions, weight, and eligible service levels for a package; and
using the information retrieved from the database and the input from the user to generate a calculated shipping cost for the package associated with at least one carrier from among the plurality of different carriers.

2. The method of claim 1, further comprising outputting, on a user interface of a computing system, the calculated shipping cost.

3. The method of claim 1, further comprising generating a plurality of calculated shipping costs for the package, each of the plurality of calculated shipping costs being associated with a different carrier.

4. The method of claim 3, wherein the shipping destination is associated with a different zone for at least two of the plurality of different carriers.

5. The method of claim 3, wherein the eligible service levels for the package are based, at least in part, on a promised delivery timeframe of the package.

6. The method of claim 3, wherein the plurality of calculated shipping costs are generated without requiring submission of rate requests to any of a plurality of carriers associated with the plurality of calculated shipping costs.

7. The method of claim 1, wherein the accessorial charges include charges for residential or commercial addresses, package dimensions or weights, delivery area, and peak season.

8. The method of claim 1, wherein the information retrieved from the database further includes fuel surcharges.

9. The method of claim 1, wherein the shipping rates are estimated in at least near realtime.

10. The method of claim 1, wherein receiving a rate calculation request comprises receiving, at a computing device exposing a rate request API, the rate calculation request.

11. The method of claim 9, wherein receiving the rate calculation request includes receiving the rate calculation request in response to user input at a rate calculation user interface.

12. A system for estimating shipping costs, comprising:
a database containing information on contracted shipping rates, zone mappings, and accessorial charges associated with each of a plurality of carriers and a retail organization;
an input device;
a display device; and
a data processing device in communication with the database, the input device, and the display device,
wherein the data processing device is configured to:
receive a rate calculation request from a user, the rate calculation request including a shipping origin, a shipping destination, dimensions, weight, and eligible service levels for a package; and
use the information retrieved from the database and the input from the user to generate a calculated shipping cost for the package associated with at least one carrier from among the plurality of different carriers.

13. The system of claim 12, wherein the database is stored locally with the data processing device.

14. The system of claim 12, wherein the accessorial charges include charges for residential or commercial addresses, package dimensions or weights, delivery area, and peak season.

15. The system of claim 12, wherein the database further contains information about vendor fuel surcharges.

16. The system of claim 12, wherein the data processing device is further configured to generate a user interface that includes a plurality of shipping costs for the package from a plurality of different carriers at one or more service levels.

17. The system of claim 12, wherein the data processing device is further configured to generate a plurality of calculated shipping costs for the package, each of the plurality of calculated shipping costs being associated with a different carrier.

18. The system of claim 17, wherein the plurality of calculated shipping costs are generated without requiring submission of rate requests to any of a plurality of carriers associated with the plurality of calculated shipping costs.

19. The system of claim 12, wherein the data processing device estimates the shipping rates in at least near realtime.

20. A non-transitory computer-readable storage medium comprising computer-executable instructions which, when executed by a processing device of a computing system, cause the computing system to:
retrieve information on contracted shipping rates, zone mappings, and accessorial charges from a database maintained by a retail organization, the database storing contracted shipping rates, zone mappings, and accessorial charges of a plurality of different carriers and specific to the retail organization;
receive a rate calculation request from a user interface, the rate calculation request including a shipping origin, a shipping destination, dimensions, weight, and eligible service levels for a package;
use the information retrieved from the database and the input from the user to generate a plurality of calculated shipping costs for the package from a plurality of different carriers without requiring submission of rate requests to any of a plurality of carriers associated with the plurality of calculated shipping costs; and
display, in the user interface, at least one of the plurality of calculated shipping costs.
